(19) United States
(12) Patent Application Publication
(10) Pub. No.: US 2016/0266666 A1
(43) Pub. Date: Sep. 15, 2016

(54) CALLIGRAPHY STYLUS FOR WRITING ON A TOUCH SENSITIVE SCREEN

(71) Applicant: Umm Al-Qura University, Makkah (SA)

(72) Inventors: Noman Ahmed Shah, Makkah (SA); Imran Ahmed Shah, Lahore (PK); Kamran Ahmed Shah, Leeds (GB)

(73) Assignee: Umm Al-Qura University

(21) Appl. No.: 14/645,629

(22) Filed: Mar. 12, 2015

(51) Int. Cl. G06F 3/0354; G06F 3/041

(52) U.S. Cl. CPC G06F 3/03545; G06F 3/0412

(57) ABSTRACT

The present invention contemplates a calligraphy stylus for writing on a touch sensitive screen. The stylus comprises an elongated pen shaped handle having a first end for making a mark on a touch sensitive screen and an opposite end for providing balance for the pen. The stylus includes a plurality of hair like conductive filaments such as metal fixed together at a first or writing end of the handle to form a brush like structure. This brush like structure has one or two vertical cuts or spaces to define two or three segments and are analogous to the spaces between teeth in a comb.

### FIELD OF THE INVENTION

This invention relates to a calligraphy stylus for writing on a touch sensitive screen and more particularly to a calligraphy stylus that defines a brush like structure that includes one or two vertical cuts that divide the stylus into two or three segments.

### BACKGROUND OF THE INVENTION

Calligraphy is a visual art that relates to writing. It is the design and execution of lettering with a broad tip instrument or brush in one strike according to Wikipedia, the free encyclopedia. A calligraphic practice can thus be defined as “the art of giving form to signs in an expressive, harmonious and skillful manner.” Calligraphy has been and will continue to be a popular art form.

However, with the increased usage of computers, touch sensitive screens and keypads are becoming more popular and present a number of problems associated with art. One problem relates to the use of a pen like stylus. Users generally use the stylus with a pen style tilt instead of a vertical configuration. For example, a U.S. Pat. No. 5,198,623 of Landmeier discloses a Method For Use In A Digitizer For Determining Pen Tilt. As disclosed in the aforementioned patent, a digitizer includes a tablet having an array of conductors and a pen-shaped, coil-containing stylus. The digitizer applies an energizing signal to either the conductors or the stylus, which signal induces voltages in the other. Then, the digitizer detects the induced voltages corresponding to the conductors, which define a voltage waveform having a positive peak, a negative peak, and a zero-crossing therebetween. The digitizer corrects for pen tilt in determining stylus position on the tablet by determining a position value for the zero-crossing using voltages in a region between the positive and negative peaks of the waveform and generating a pen tilt correction value using the position value and voltages in a region outside the positive and negative peaks. Then, the pen-tilt correction value and a preferably cyclic-error-corrected value for the position of the zero-crossing are combined to yield a relatively accurate pen-tilt-compensated determination of stylus position.

A second U.S. Pat. No. 5,214,428 of Allen is directed to a Data Input Grid for a Computer. As disclosed, the apparatus includes a grid panel having a pattern of grooves in the panel surface and a plurality of sensors along the grooves. The sensors sense the passage of a stylus along the grooves and feed the stylus movement information to electrical circuitry which interprets the movements as data. In an alternate embodiment, the grooves have lower channels in which a lower portion of the stylus guide moves. The stylus guide has a ball-type universal joint on the upper portion to which is connected a fitting for retaining the end of the stylus.

Finally, a more recent patent of Nagai et al., U.S. Pat. No. 6,104,388 discloses a Handwriting Input Device has a pen stem housed inside a pen body formed in the shape of a pen, with the tip of the pen stem left sticking out of an opening formed at one end. This input device further has a pen stem holder having a hemispherical projection formed in a middle portion, an omni-directional pressure sensor having an actuator and an operation shift formed integrally, a data processor for processing electric signals outputted from the sensor, and a connector for connecting the tail-end cap portion of the pen stem holder to the operation shaft of the sensor. Thus, this input device detects the force applied to the tip of the pen stem by sensing pressure; in addition, it also detects the up/down movement of the pen stem by sensing pressure.

Notwithstanding the above, it is believed that there is a need for an improved calligraphy stylus and a potential commercial market for an improved stylus in accordance with the present invention. There should be a relatively large potential market since the stylus in accordance with the present invention facilities making various widths of letters and other shapes for calligraphy on a touch sensitive screen.

### SUMMARY OF THE INVENTION

In essence, the present invention contemplates a calligraphy stylus for writing on a touch sensitive screen in Arabic, English, Farsi and other languages. The stylus comprises/or consists of an elongated pen-shaped handle having a first or writing end for making a mark on a touch sensitive screen and an opposite end for providing balance to the pen. The stylus includes a plurality of relatively coarse hair-like conductive filaments. These filaments are fixed together at a first or writing end of the handle to form a brush-like structure. These brush like structures define a generally oval shaped cross section with one or two vertical cuts or spaces to define two or three segments that are analogous to the spaces between teeth in a comb. In a preferred embodiment of the invention, the filaments are of a metal or alloy.

The invention will now be described in connection with the accompanying drawings wherein like reference numbers are used to identify like parts.

DESCRIPTION OF THE DRAWINGS

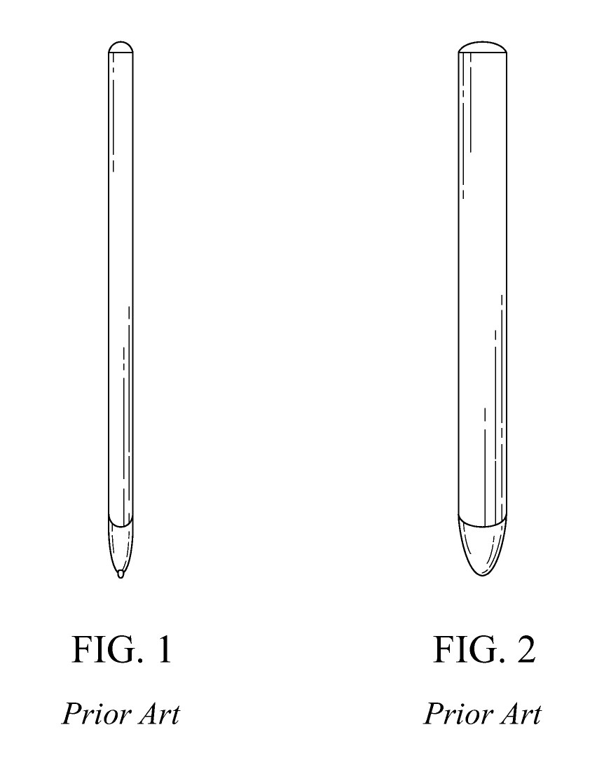

FIG. 1 is a schematic illustration of a conventional pressure sensitive screen;

FIG. 2 is a schematic illustration of a conventional stylus for a capacitive sensitive screen;

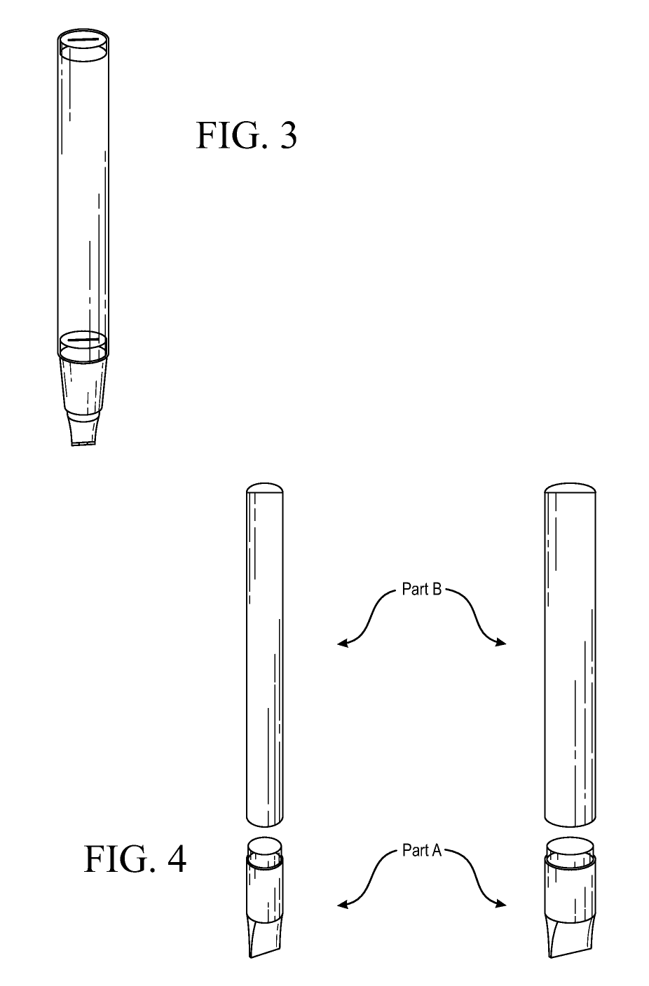

FIG. 3 is a side elevational view of a pen like handle and brush like stylus in accordance with a first embodiment of the invention; as shown one cut provides two segments with a 90° cut to provide a flat edge across the filaments;

FIG. 4 is a side elevational view of a pen like handle and brush like structure in accordance with a second embodiment of the invention;

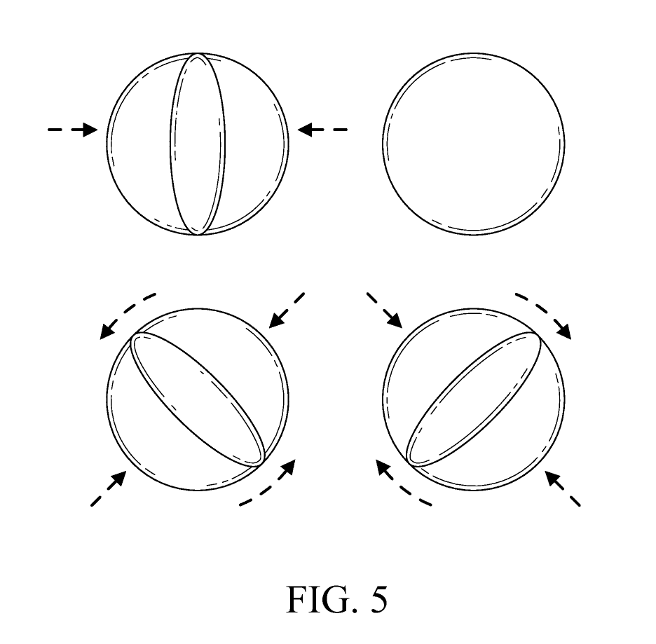

FIG. 5 is a side elevational view of a plurality of styluses in different sizes and shapes; and

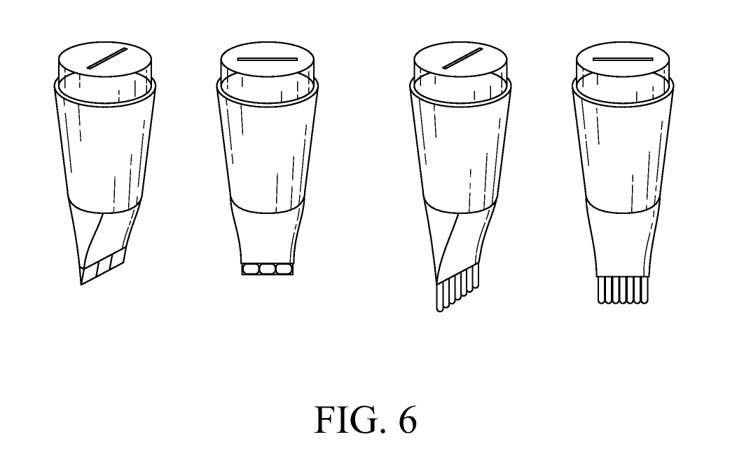

FIG. 6 is a side elevational view of a plurality of styluses with single and multiple cuts.

### DESCRIPTION OF THE PREFERRED EMBODIMENTS OF THE INVENTION

Modern calligraphy ranges from functional inscriptions and designs to fine-art pieces where the letters may or may not be completely legible. Classical calligraphy differs from typography and non-classical hand-lettering, though a calligrapher may practice both.

The invention that is a “calligraphy stylus” is designed to help and promote calligraphy Arts on inspiring from Arabic and Asian Calligraphic Scripts. The invention is suitable to compose (write, draw sketch and/or build-up) Arabic, Persian, Urdu, Hangeul (Korean), Japanese, Chinese as well as other Asian language Manuscripts/Calligraphies and/or Creative Artworks. This innovation will help the immediate development & progressive art work and calligraphy (of western, eastern and southern writing cultures). This Stylus works on commonly used touch sensitive screens (with a capacitance or resistance base sensitivity) with an adjustable size and sensitivity of the (replaceable) conductive stylus tip(s) with oblique angle (slanting angular) cutting edges (FIG. 6) or in a shape like a comb to represent a brush style work. Different versions of devices drivers or enables a Calligraphy stylus to be used on different operating systems of touch screen devices.

A calligraphy stylus in accordance with the invention works on commonly used touch sensitive screens with a capacitance or resistance base sensitivity and an adjustable size and sensitivity of the replaceable conductive stylus tip(s) with or without an oblique angle (slanting angular) edge or in a shape like a comb with one or two vertical spaces.

A stylus in accordance with the invention provides a new creative style for use with a touch sensitive screen and users may enjoy the same traditional experience they were accustomed to when working on paper or canvas. A calligraphy stylus tip or bristle may be silicon with a conductive coat, paint or metal such as copper or aluminum or an alloy. This material can also be rubberized/rubber-like conductive silicon. The length of the tip or bristles may be varied in length to soften or change the effect of touch or comfort of the user, type of touch surface and generally will range between 2 mm to 20 mm or equivalents. Depending upon stroke, width desired, angle and language of selection as well as corresponding length ranges the width of the tip may vary between 2 mm to about 30 mm Finally, the distance between number of nodes/parts of tip or bristles may also vary depending upon material, thickness, conductivity, nature of touch surface etc.

As a stylus tip is designed (like the nib of a pen with a Cutting Edge) that introduces a new style of the stylus tip that will help users to write in rotating angles with flexibility of transferring their hand writing experience on to the surface of different common devices with touch screens. Users of the innovation will be able to easily twist, rotate stylus in any desired shapes like tilting in slope, horizontal, vertical, straight or curve or angular to make a harmonic pattern distribution with the same or different weights/pressure dark or light and/or size (smaller or bigger, medium or larger) strokes or lines to draw on a touch screen device. Calligraphy stylus works with a combination of device drivers (enabling calligraphy stylus for different operating systems of different touch screen devices).

A device driver of calligraphy stylus is featured with calibration facility to adjust the sensitivity of the calligraphy stylus (sensitivity in terms of, capacitance and/or resistance, roundness or thickness) as well as angle and angular stroke or any directional movement on the surface of the touch screens devices.

The invention as disclosed and claimed herein is an (apparatus, device, or system) and (process, method, technique) for touch screen devices. A stylus is designed for the purpose of calligraphy. The apparatus comprises a stylus handle and a replaceable (changeable) stylus tip holder with a calligraphy stylus tip with an adjustable sensitivity (capacitance and/or resistance) and calligraphy stylus device driver (separate versions for different operating systems) enables the innovative calligraphy stylus to be used on (commonly available different types of) touch screen devices to write, compose and/or draw sketches of calligraphic manuscripts and artworks (in addition to common functions of a commonly available stylus).

The calligraphy stylus handle is a stick type portion of the stylus gripped in the user's figures.

The calligraphy stylus tip holder is designed with conductive material and also has capacitance interlinked with the calligraphy stylus handle. Different replaceable/changeable calligraphy stylus tip holders refer to different size and types of tips.

The calligraphy stylus tip(s) are designed with conductive material and also have capacitance interlinked with the calligraphy stylus holder and handle. The shape of the tip is like a nib of a commonly used calligraphic pen(s) but has two or three legs which are separated with one or two vertical cuts. The edge of the tip has an angular (oblique, acute or 90° angle) or cut.

Although some embodiments of the calligraphy stylus handle and calligraphy stylus tips are shown in the drawings, the applicants specifically contemplate that any feature disclosed herein may be used together or in combination with any other feature or any embodiment of the invention.

The calligraphy stylus tip (may appear to be like a traditional nib) it is especially designed with one or two vertical cuts into two or three tines/legs. Applicants claim herein that splitting the tip's edge into a minimum of two separate parts (legs/tines) is an important feature for enabling a calligrapher to use it on a touch sensitive screen. The stylus or pen may be held in a vertical or tilted position in accordance with the comfort or discretion of an individual.

Calligraphy stylus works with various device drivers for different operating systems of different touch screen devices. Calligraphy stylus device drivers is a program to be installed on touch sensitive screens. Device driver of a calligraphy stylus provides calibration facility to adjust the sensitivity of a calligraphy stylus (sensitivity in terms of, capacitance and/or resistance, roundness or thickness) as well as angle and/or stroke or any directional movement on the surface of the touch screens devices.

A calligraphy stylus tip in accordance with a preferred embodiment of the invention has two vertical cuts splitting tip edges into three tines/legs that reflect three points on the surface of a touch sensitive screen (apparatus, device, system). Normally each pointer of the stylus reflects a shadow in round shape and multiple round circles make a line. Device driver helps to suppress this line from two sides making it sharp and thinner. Calibration facility of the device driver also helps to adjust the sensitivity, thickness and reflection of the points of calligraphy stylus.

While the invention has been defined in accordance with its preferred embodiments, it should be recognized that changes and modifications may be made therein without departing from the scope of the appended claims.

What is claimed is:

1. A calligraphy stylus for writing on a touch sensitive screen in Arabic, Chinese, English, Farsi and other languages, said stylus comprising:
an elongated pen shaped handle having a first end for making a mark on a screen and an opposite end for balance, and a plurality of coarse hair like filaments fixed together in said first end of said handle to form a brush like structure; and,
wherein said brush like structure has a generally oval shaped cross section and defines one or two vertical cuts along a minor axis to divide the brush into two or three generally equal segments.

2. A calligraphy stylus for writing on a touch sensitive screen in Arabic, Chinese, English, Farsi and other languages according to claim 1, in which said stylus is an electrical conductive stylus.

3. A calligraphy stylus for writing on a touch sensitive screen in Arabic, Chinese, English, Farsi and other languages according to claim 2, in which said stylus includes a single vertical cut.

4. A calligraphy stylus for writing on a touch sensitive screen in Arabic, Chinese, English, Farsi and other languages according to claim 2, in which said stylus includes two vertical cuts to divide the stylus into three generally equal segments.

5. A calligraphy stylus for writing on a touch sensitive screen in Arabic, Chinese, English, Farsi and other languages according to claim 2, in which said brush like structure forms a straight edge at an acute, obtuse or 90° angle.

6. A calligraphy stylus for writing on a touch sensitive screen in Arabic, Chinese, English, Farsi and other languages according to claim 2, in which said brush like structure forms an edge at an acute angle.

7. A calligraphy stylus for writing on a touch sensitive screen in Arabic, Chinese, English, Farsi and other languages according to claim 2, in which said brush like structure forms an edge at 90° to a vertical axis.

8. A calligraphy stylus for writing on a touch sensitive screen in Arabic, Chinese, English, Farsi and other languages, said stylus comprising:
an elongated pen shaped handle having a first end for making a mark on a screen and an opposite end, and a plurality of coarse hair like filaments fixed together in said first end of said handle to form a brush like structure; and
wherein said brush like structure has a generally oval shaped cross section and defines a pair of vertical parallel cuts across a minor axis of said oval shape to divide the brush into three generally equal length segments.

9. A calligraphy stylus for writing on a touch sensitive screen in Arabic, Chinese, English, Farsi and other languages according to claim 8, in which said stylus is an electrical conductive stylus.

10. A calligraphy stylus for writing on a touch sensitive screen in Arabic, Chinese, English, Farsi and other languages according to claim 8, in which said stylus includes a single vertical cut.

11. A calligraphy stylus for writing on a touch sensitive screen in Arabic, Chinese, English, Farsi and other languages, said stylus consisting of:
an elongated pen shaped handle having a first end for making a mark on a screen and an opposite end, and a plurality of coarse hair like filaments fixed together in said first end of said handle to form a brush like structure; and
wherein said brush like structure has a generally oval shaped cross section and defines a pair of vertical parallel cuts across a minor axis of said oval shape to divide the brush into three generally equal length segments.
